(19) United States
(12) Patent Application Publication
(10) Pub. No.: US 2009/0070310 A1
(43) Pub. Date: Mar. 12, 2009

(54) ONLINE ADVERTISING RELEVANCE VERIFICATION

(75) Inventors: ABHINAI SRIVASTAVA, REDMOND, WA (US); YING LI, BELLEVUE, WA (US); TAREK NAJM, KIRKLAND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/851,447

(22) Filed: Sep. 7, 2007

(51) Int. Cl. G06F 17/30

(52) U.S. Cl. 707/5; 707/E17.014

(57) ABSTRACT

Online relevance verification is performed to provide relevant advertisements to search queries received at a search engine. Relevance of an advertisement for a received search query is determined by comparing the content of a landing page associated with the advertisement against search results for the search query. Relevance may then be used to filter irrelevant advertisements from consideration and/or may be used in ranking advertisements during an auction process in conjunction with monetization factors. Selected advertisements may then be returned in response to the search query.

### BACKGROUND

Online advertising has become a significant aspect of the Web browsing experience. Today, many search engine providers receive revenue through advertisements positioned adjacent to a user's query results. In particular, when a user submits a search query to a search engine, the search engine will select advertisements and present the advertisements in conjunction with general search results for the user's query. Typically, search engine providers receive payment from advertisers based upon pay-per-performance models (e.g., cost-per-click or cost-per-action models). In such models, the advertisements returned with search results for a given search query include links to landing pages that contain the advertisers' content. A search engine provider receives payment from an advertiser when a user clicks on the advertiser's advertisement to access the landing page and/or otherwise performs some action after accessing the landing page (e.g., purchases the advertiser's product).

In the pay-per-performance model, search engine providers select advertisements for search queries based on monetization. In other words, search engine providers select advertisements to return for a given search query to maximize advertising revenue. This is typically performed through an auction process. Search engine providers permit advertisers to bid for particular words and/or phrases as a way for selecting advertisements and determining the order in which advertisements will be displayed for a given search query. Bids are typically made as cost-per-click (CPC) commitments. That is, the advertiser bids a dollar amount it is willing to pay each time a user selects or clicks on a displayed advertisement presented as a result of a given search query.

One monetization method that search engines may use to determine selection and placement of different advertisements is to simply rank by the CPC bid and give the best or most prominent placement to the advertiser bidding the highest amount. For instance, Hotel A may “bid” or agree to pay the search engine $1.00 for each user that accesses its information as a result of its advertisement appearing with the search results of a given query while Hotel B may “bid” or agree to pay the search engine $1.50 for each user that accesses its information upon its advertisement appearing with the query results. In this instance, Hotel B would “win” the bid and, accordingly, its advertisement would be placed in a more prominent position on the web page on which the results of a search initiated by a query that exactly or partially matches the bid terms are displayed.

Another monetization method that search engines may use to determine the selection and placement of advertisements as the result of a particular search query is to take the product of the advertiser's CPC bid and the probability that a user will access the information associated with the advertisement. This probability is typically determined based on historical information regarding advertisements' click-through rates (CTRs), which is the rate at which users have clicked on a particular advertisement when presented. The most prominent placement is provided to the advertiser having the highest product (CPC bid×CTR). In this way, the search engine provider can attempt to maximize its expected profit.

The selection of advertisements based on CPC bids, CTRs, and/or other monetization factors, however, often result in irrelevant advertisements being returned for search results. For example, if an advertiser's landing page is about children books and the advertiser bids on the bid term “children,” it is possible that the advertisement would be returned for all search queries that include the term “children.” This may often result in the advertisement being presented for search queries for which the advertisement is irrelevant, such as “orphaned children” and “children medical conditions,” for example. Showing irrelevant advertisements for search queries hurts a search engine provider's revenue as the irrelevant advertisements are not likely to be selected. Additionally, providing irrelevant advertisements hurts the brand-name for the search engine, as advertisers are dissatisfied when their advertisements are irrelevant to the search queries for which they are returned. In particular, users are not only less likely to click on an irrelevant advertisement but are also less likely to purchase a product or otherwise complete an action when an irrelevant advertisement is selected by a user. As such, advertisers are likely to enter lower bids to search engines providing irrelevant advertisements.

Some approaches have been taken to check the relevance of bid terms for submitted advertisements (and their associated landing pages) at the time of their submission to the search engine provider as an attempt to provide relevant advertisements. In particular, the landing page is analyzed to determine whether the bid terms the advertiser selected are relevant to the landing page. If it is determined that the advertiser has bid on irrelevant terms, the bid terms may be removed from the advertisement and/or the search engine may refuse to use the advertisement. However, verifying the relevance of bid terms for a given advertisement does not ensure that relevant advertisements will be selected for a given search query. For instance, in the above example, the bid term “children” would be determined to be relevant to the advertisement relating to children books. Accordingly, the advertisement could still be returned for search queries, such as “orphaned children” and “children medical conditions,” despite the irrelevance of the advertisement to the search queries.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to verifying the relevance of advertisements for search queries received at a search engine. In particular, the relevance of an advertisement for a given search query is determined by comparing the content of a landing page associated with the advertisement against search results for the search query. Advertisement relevance for a given search query is used to select and/or rank advertisements to return in conjunction with search results for the search query.

In some embodiments, advertisement relevance for a given search query is used to identify irrelevant advertisements and remove the irrelevant advertisements from consideration. Irrelevant and relevant advertisements are determined in some embodiments, by comparing a relevance score for each advertisement against a relevance threshold. Accordingly, after removing irrelevant advertisements from consideration, an auction process that considers only relevant advertisements proceeds using monetization factors (such as CPC bid and CTRs) to select and rank advertisements. In other embodiments, advertisements' relevance for a given search query are used during the auction process in conjunction with monetization factors to select and order (e.g., rank) advertisements to return for the search query. In further embodiments, advertisement relevance for a given search query is used to both filter irrelevant advertisements from consideration before the auction process as well as to select and rank advertisements in conjunction with monetization factors during the auction process. In still further embodiments, an auction process is conducted to provide a set of candidate advertisements, which are then filtered based on relevance to produce a set of advertisements to return for the search query.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is a block diagram of an exemplary system in which embodiments of the invention may be employed;

FIG. 3 is a flow diagram showing a method for providing relevant advertisements for a given search query in accordance with an embodiment of the present invention;

FIG. 4 is a flow diagram showing a method for selecting advertisements by filtering irrelevant advertisements before an auction is performed in accordance with an embodiment of the present invention;

FIG. 5 is a flow diagram showing a method for selecting advertisements by removing irrelevant advertisements after an action has been performed in accordance with an embodiment of the present invention;

FIG. 6 is a flow diagram showing a method for calculating a relevance score for a landing page and search query pair in accordance with an embodiment of the present invention; and

FIG. 7 is a block diagram showing an overall architecture for an online relevance verification system for providing relevant advertisements to search queries in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As indicated previously, embodiments of the present invention provide online relevance verification to present relevant advertisements in response to search queries. Accordingly, in one aspect, an embodiment of the invention is directed to a computerized method for providing advertisements in response to a search query. The method includes receiving the search query. The method also includes determining a relevance score for an advertisement and the search query by comparing content of a landing page associated with the advertisement against search results for the search query. The method further includes selecting one or more advertisements based at least in part on the relevance score and at least one monetization factor. The method still further includes communicating the advertisements for presentation.

In another embodiment, an aspect of the invention is directed to one or more computer-readable media embodying computer-useable instructions for performing a method of providing a set of advertisements for a given search query. The method includes accessing information regarding a set of search results for the given search query and accessing information regarding content of a landing page associated with an advertisement. The method also includes calculating a relevance score indicative of the relevancy of the advertisement for the given search query by comparing the information regarding the set of search results against the information regarding the content of the landing page. The method further includes in response to receiving a search request from a user including the given search query or an equivalent thereof, selecting a set of advertisements based at least in part on the relevance score for the advertisement and at least one monetization factor. The method further includes communicating the set of advertisements for presentation.

In yet a further aspect of the invention, an embodiment is directed to one or more computer-readable media embodying computer-useable instructions for performing a method of providing a set of advertisements for a search query. The method includes receiving the search query. The method also includes performing an auction based on at least one monetization factor to identify a set of candidate advertisements for the search query. The method further includes determining a relevance score for at least one candidate advertisement by comparing content from a landing page associated with the at least candidate advertisement against search results for the search query. The method also still further includes selecting a set of advertisements by removing one or more of the candidate advertisements from the set of candidate advertisements based on a relevance score and communicating at least a portion of the set of advertisements for presentation.

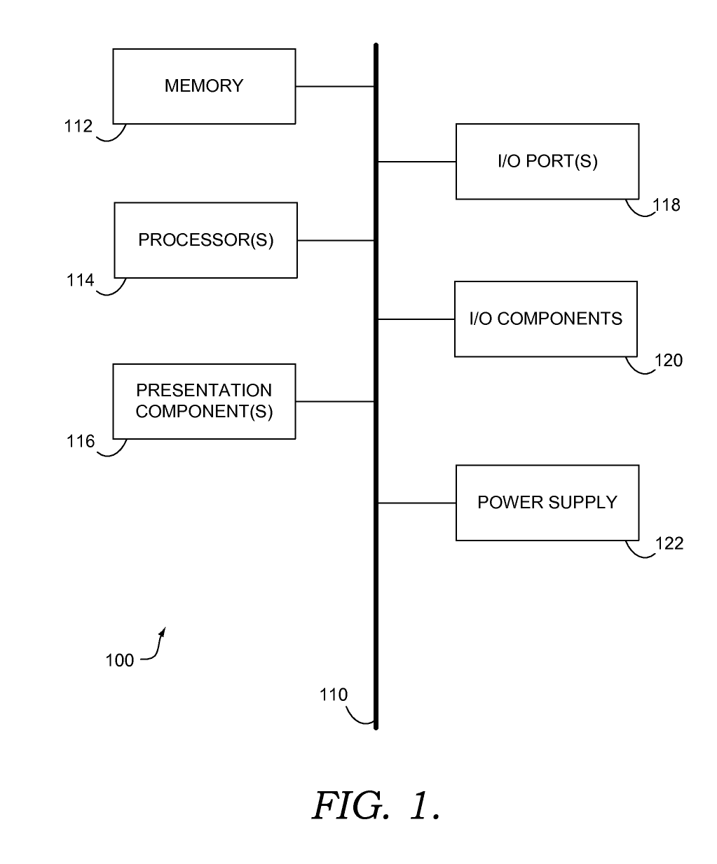

Having briefly described an overview of the present invention, an exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

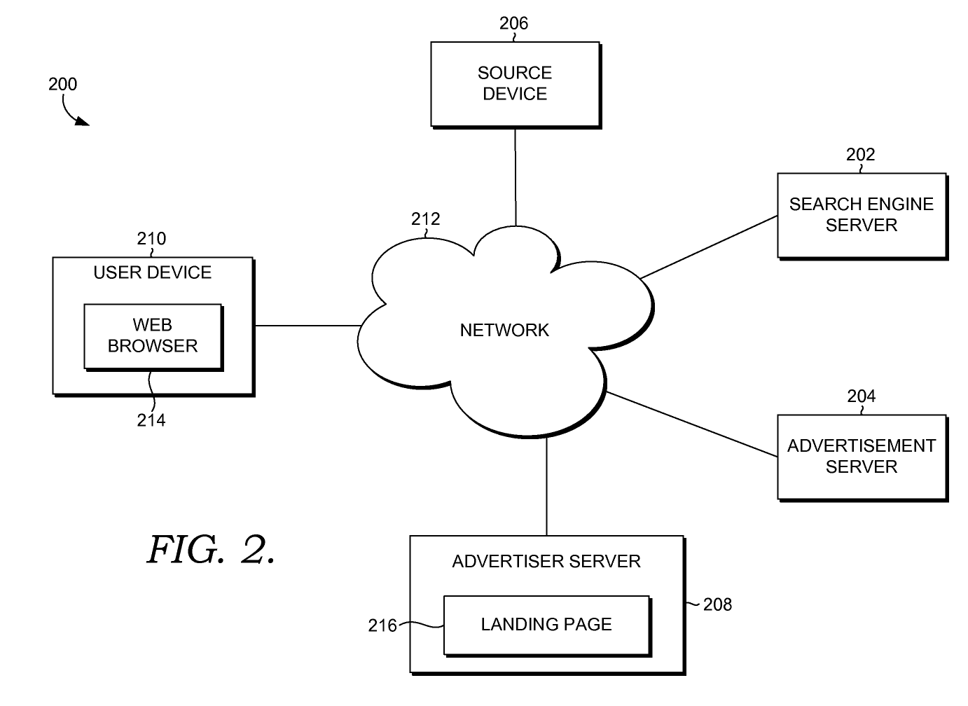

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 may include a search engine server 202, an advertisement server 204, a source device 206, an advertiser server 208, and a user device 210. Each of the components shown in FIG. 2 may be any type of computing device, such as computing device 100 described with reference to FIG. 1, for example. The components may communicate with each other via a network 212, which may include, without limitation, one or more local area networks (LANs) and/or wide area networks (WANs). Such networking environments are commonplace in offices, enterprise-wide computer networks, intranets, and the Internet. It should be understood that any number of search engine servers, advertisement servers, source devices, advertiser servers, user devices, and networks may be employed within the system 200 within the scope of the present invention. Additionally, other components not shown may also be included within the system 200.

Source devices, such as the source device 206, may maintain a variety of content such as web pages. For example, the source device 206 may be a web server that maintains multiple web pages. The search engine server 202 may access web page information by communicating with these source devices. For example, the search engine server 202 may periodically crawl the source device 206 to access web page information and/or index the information.

By accessing and/or indexing web page information from various source devices, the search engine server 202 may provide search capabilities to user devices, such as the user device 210. In particular, a user may employ a web browser 214 or other mechanism on the user device 210 to communicate with the search engine server 202. For instance, a user may issue a search query to the search engine server 202 and receive search results. The search query may comprise one or more search terms, and the search engine server 202 attempts to provide search results that are relevant to those search terms.

In embodiments of the present invention, advertisements are also selected based on the search query and returned to the user device 210 with the search results. Each advertisement may be provided by an advertiser and associated with a landing page. For instance, an advertiser may maintain an advertiser server 208, which includes a landing page 216 associated with one or more advertisements for the advertiser.

Advertisements to return for search queries may be selected by an advertisement server 208 and presented to the user via the user device 210 in hyperlink form, allowing user interaction with the advertisements. As such, a user may select an advertisement and be directed to a landing page associated with the advertisement, such as the landing page 216 located at the advertiser server 208. In embodiments of the invention, relevance of advertisements for given search queries is checked to reduce and/or prevent the presentation of irrelevant advertisements. In particular, advertisements are not selected based on monetization factors alone (such as CPC bids and CTRs) but are also selected based on relevance of the advertisements for search queries. The relevance of an advertisement for a given search query is determined based on a comparison of the content of a landing page for an advertisement (e.g,. landing page 216) against search results for the given search query. In some embodiments, if an advertisement is determined to be irrelevant, the advertisement will be rejected for the search query. Accordingly, an auction may be performed for the search query without consideration of the irrelevant advertisement. In other embodiments, an auction for a search query may be performed using relevance scores for advertisements in conjunction with monetization factors, such as CPC bids and CTRs, with or without initially filtering advertisements based on relevance. In further embodiments, auction results may be filtered based on relevance to provide a set of advertisements to return to the user device 210.

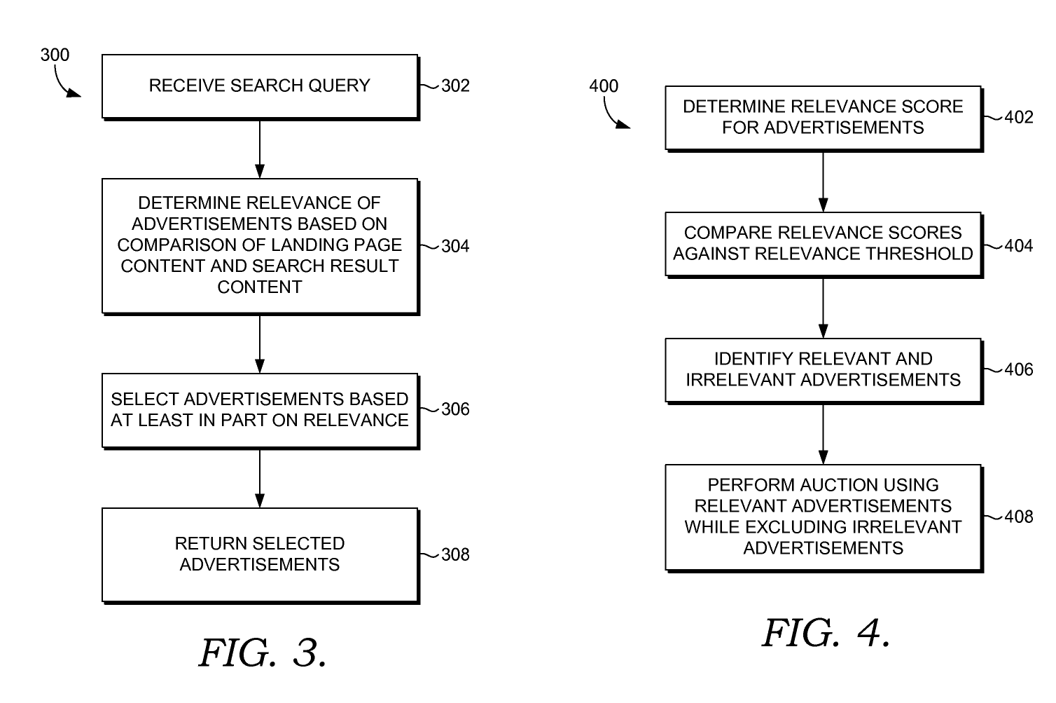

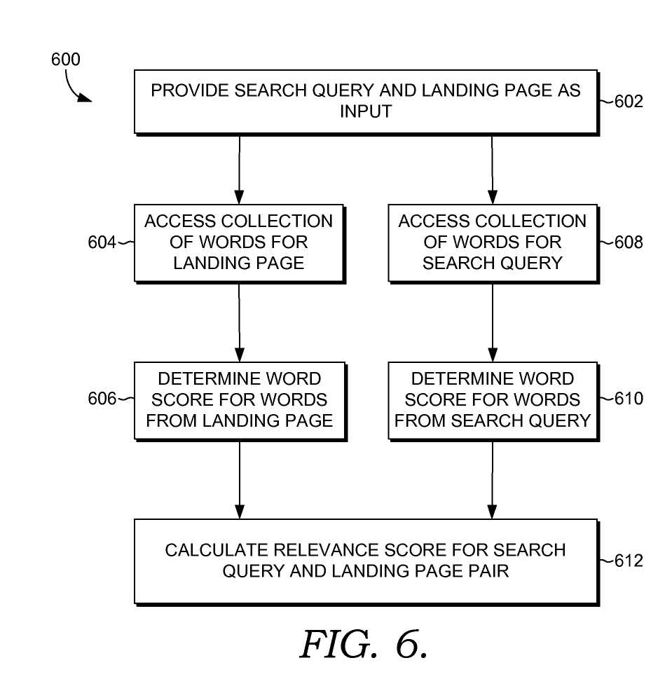

Turning now to FIG. 3, a flow diagram is provided illustrating an exemplary method 300 for selecting advertisements relevant to a given search query in accordance with an embodiment of the present invention. Initially, as indicated at block 302, a search query is received. For instance, a user may employ a web browser on the user's computing device to access a search engine, enter a search query, and issue a search request. Subsequent to, simultaneously with, or prior to receipt of the search query, relevance of advertisements for the search query is determined, as shown at block 304. The relevance of an advertisement for a given search query is determined based on a comparison of content of a landing page associated with that advertisement against content of search results for the given search query. In embodiments, a relevance score is calculated and used to represent the relevance of the advertisement to the search query. An exemplary method for determining relevance in accordance with one embodiment of the invention is discussed more fully below with reference to FIG. 6. In some embodiments, information may not be available for some advertisements to allow calculation of a relevance score. Accordingly, a default relevance score may be used for those advertisements. The default score may be a predefined score or may be dynamically determined, for instance, by setting the default score as the average of calculated relevance scores for a given search query. In some embodiments, a category match score may be determined in conjunction with or as a part of the relevance score and used in the advertisement selection process. Categorization methods are well known in the art and, as such, are not described in further detail herein.

As shown at block 306, a set of advertisements are selected based at least in part on the relevance of the advertisements for the search query. Relevance may be used in a number of different manners to select advertisements for a search query in various embodiments of the invention. In one embodiment, relevance scores may be used to remove irrelevant advertisements from consideration before a final auction using monetization factors is conducted to select the advertisements to return to the requesting device. For instance, as shown in FIG. 4, a flow diagram illustrates a method 400 in which irrelevant advertisements are removed before conducting an auction to select advertisements to return for a search query. As shown at block 402, relevance scores are determined for advertisements. The relevance score for each advertisement is then compared against a relevance threshold, as shown at block 404. If the relevance score for a given advertisement does not meet the relevance threshold, the advertisement is considered to be irrelevant. Alternatively, if the relevance score for a given advertisement does meet the relevance threshold, the advertisement is considered to be relevant. Accordingly, relevant and irrelevant advertisements are identified based on the comparison of relevance scores to the relevance threshold, as shown at block 406. An auction is then performed using the relevant advertisements while excluding the irrelevant advertisements, as shown at block 408. Accordingly, in the present embodiment, irrelevant advertisements are filtered before an auction is conducted to select advertisements to return for a given search query, thereby preventing such irrelevant advertisements from being presented in response to the search query.

Returning again to FIG. 3, in another embodiment, advertisements are not filtered by a relevance threshold but are selected at block 306 by conducting an auction process using relevance scores in conjunction with monetization factors, such as CPC bids and CTRs, to rank advertisements. A variety of ranking formulas may be used within various embodiments of the invention. The ranking formulas may incorporate a variety of different monetization factors in conjunction with relevance scores to rank advertisements. The ranking formulas may be configurable to allow different weighting to be applied to relevance and monetization. Accordingly, the ranking formulas may be easily adapted to favor relevance over monetization or vice versa. By way of example only and not limitation, one ranking formula used in an embodiment of the invention may be expressed by the following equation:

Rank=(ε+Bid)^{1-Σiki}*(ε₁+PClick)^{k1}*(ε₂+RVScore)^{k2}*

Wherein Bid represents CPC bid value, PClick represents CTR, RVScore represents relevance score, and for every i, εᵢ is any number, kᵢ ε[0,1] and

$${\sum }_{i} {k}_{i} \leq 1.$$

In a further embodiment, advertisements may be selected at block 306 by using relevance scores to remove irrelevant advertisements before an auction process is conducted and during the auction process to rank advertisements. Accordingly, in the present embodiment, irrelevant advertisements are identified based on a comparison of relevance scores against a relevance threshold. The irrelevant advertisements are filtered and an auction is conducted for the relevant advertisements in which the relevant advertisements are ranked based on both monetization and relevance. Any and all such variations are contemplated to be within the scope of embodiments of the present invention.

The selected advertisements are returned to the requesting device (e.g., the user device 202 of FIG. 2) for presentation, as shown at block 308. In embodiments, the selected advertisements are returned with search results selected based on the search query. Typically, presentation of the advertisements comprises displaying the advertisements on a display device (e.g., associated with the user device 202 of FIG. 2). However, other types of presentation, such as an audible presentation, may also be provided within the scope of embodiments of the present invention.

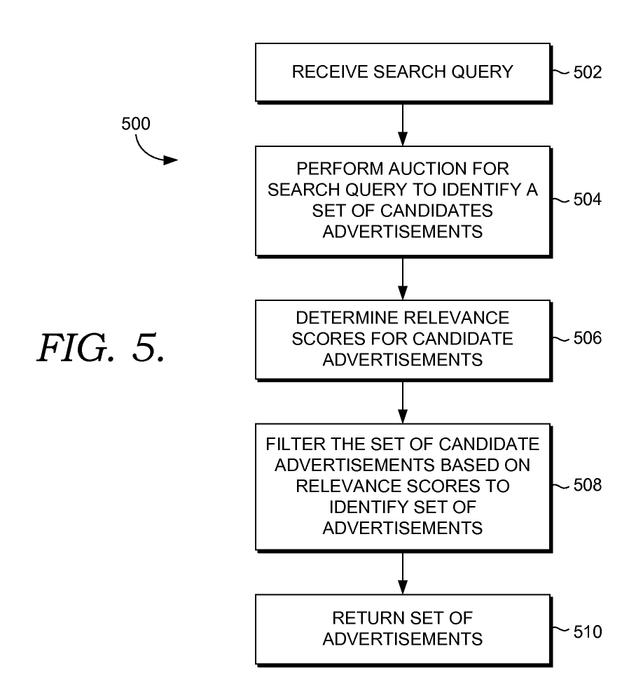

Turning to FIG. 5, a flow diagram is provided illustrating an exemplary method 500 for filtering irrelevant advertisements from being returned for a search query in accordance with another embodiment of the present invention. Initially, as shown at block 502, a search query is received, for instance, from a user entering the search query via a user device. An auction is performed to select advertisements for the search query based on monetization factors, such as CPC bid and CTRs, as shown at block 504. The auction identifies a set of candidate advertisements. Typically, these advertisements (or a portion thereof) would be returned for the search query. In the present embodiment, however, a relevance score is determined for each of the candidate advertisements, as shown at block 506. Generally, the relevance score for a given candidate advertisement is determined by comparing the contents of a landing page associated with the candidate advertisement against search results for the search query. The relevance score may be calculated in a variety of different manners within the scope of embodiments of the invention. One such method is described in further detail below with reference to FIG. 6. In some cases, information may not be available to calculate a relevance score for a given advertisement and a default relevance score may be used.

As shown at block 508, the set of candidate advertisements is filtered based on the relevance scores to identify a set of advertisements. In particular, relevance scores for the candidate advertisements are compared against a relevance threshold. Those candidate advertisements having a relevance score below the relevance threshold are deemed to be irrelevant and are removed from the set of candidate advertisements.

The set of advertisements (or at least a portion thereof) is then returned to the requesting device (e.g., the user device 202 of FIG. 2) for presentation, as shown at block 510. In embodiments, the set of advertisements are returned with search results selected based on the search query. Typically, presentation of the advertisements comprises displaying the advertisements on a display device (e.g., associated with the user device 202 of FIG. 2). However, other types of presentation, such as an audible presentation, may also be provided within the scope of embodiments of the present invention.

Referring now to FIG. 6, a flow diagram is provided illustrating an exemplary method 600 for calculating a relevance score for an advertisement and query pair in accordance with an embodiment of the present invention. Initially, as shown at block 602, a search query and landing page are provided as input. As noted previously, each advertisement has an associated landing page. In embodiments, the content of the landing page is compared against search results for the search query to determine the relevance of the associated advertisement for the search query. Accordingly, as shown at block 604, a collection of words from the landing page are accessed. Typically, the landing page is crawled to gather the collection of words, although, in some embodiments, the landing page may have been previously crawled such that the collection of words are available in a data store from which they may be accessed.

As shown at block 606, a word score is determined for each word from the collection of words for the landing page. In an embodiment, the word score comprises a term frequency—inverse document frequency (TFIDF) score. Although other forms of TFIDF scores may be employed in various embodiments of the invention, the following equation is used in an embodiment to calculate the word score for a given word:

WordScore=(TF*log(N/DF))^{k}

Wherein TF represents the frequency that the word appears in the document; N is the number of documents in a document corpus; DF is the number of documents in the document corpus that contain the word; and k is a coefficient determined experimentally for enhancing the result quality. Experimentation has shown that good results may be achieved using a k between 0.2 and 0.7, and preferably using k=0.45.

As shown at block 608, a collection of words is also accessed for the search query. In particular, a search is performed using the search query, and the collection of words is gathered from the search results. In an embodiment, the words are gathered from the top N (e.g., top 100) search results. In some embodiments, the words are gathered from the content of documents associated with the search results (e.g., by crawling the documents). In other embodiments, the words are collected from search result snippets. Experimentation has shown that using search result snippets reduces processing time while providing accurate results. Information from search results for the search may have been previously gathered such that the collection of words are available in a data store from which they may be accessed. At block 610, a word score is determined for each word in the collection of words for the search query. The word score may be calculated based on a TFIDF score such as that described above for the landing page.

Using the word scores determined for the collection of words for both the landing page and the search query, a relevance score for the landing page and search query pair is determined, as shown at block 612. In various embodiments of the invention, the relevance score may be calculated using all words or only a portion of words for a search query and landing page. For instance, in one embodiment, the top N words (e.g., top 100 words) based on their TFIDF score are selected for the landing page and designated as dominant words for the landing page. Similarly, the top N words (e.g., top 100 words) are selected for the search query and designated as dominant words for the search query. In such an embodiment, the relevance score is determined based on the dominant words for the landing page and the search query. In some embodiments of the invention, dominant word stores are maintained for search queries and landing pages. The dominant word stores store the dominant words and word scores for various search queries and landing pages. Accordingly, because relevance scores may need to calculated for various search query and landing page pairs, instead of accessing a collection of words and determining a word score of each word for the landing pages and search queries (as in blocks 504, 506, 508, and 510), the dominant word stores may be accessed to obtain word scores for a given landing page and search query pair for use in calculating relevance.

By way of example only and not limitation, the relevance score for a given landing page and search query pair may be determined by the following process. First, a vector distance is calculated based on the vector of words for the landing page and search query. In an embodiment, the vector distance is calculated using a cosine similarity for the collection of words according to the following equation:

$$Cos Sim = \frac{( A \cdot B )}{( \vert A \vert \times \vert B ) \vert}$$

Wherein A represents a word-bag containing word scores for the collection of words for the search query and B represents a word-bag containing word scores for the collection of words for the landing page.

The vector distance is then converted to a linear value using, for instance, the following equation:

$$x = \frac{2 {cos}^{- 1} ( Cos Sim )}{π}$$

A relevance score for the search query and landing page pair is next determined by converting to a signal function using, for instance, the following equation:

$$R = \frac{( N - {N}^{x} )}{( N - 1 )}$$

Wherein R represents the relevance score, N is a system value (typically 1000), and x is the linear value of the vector distance such as that shown hereinabove.

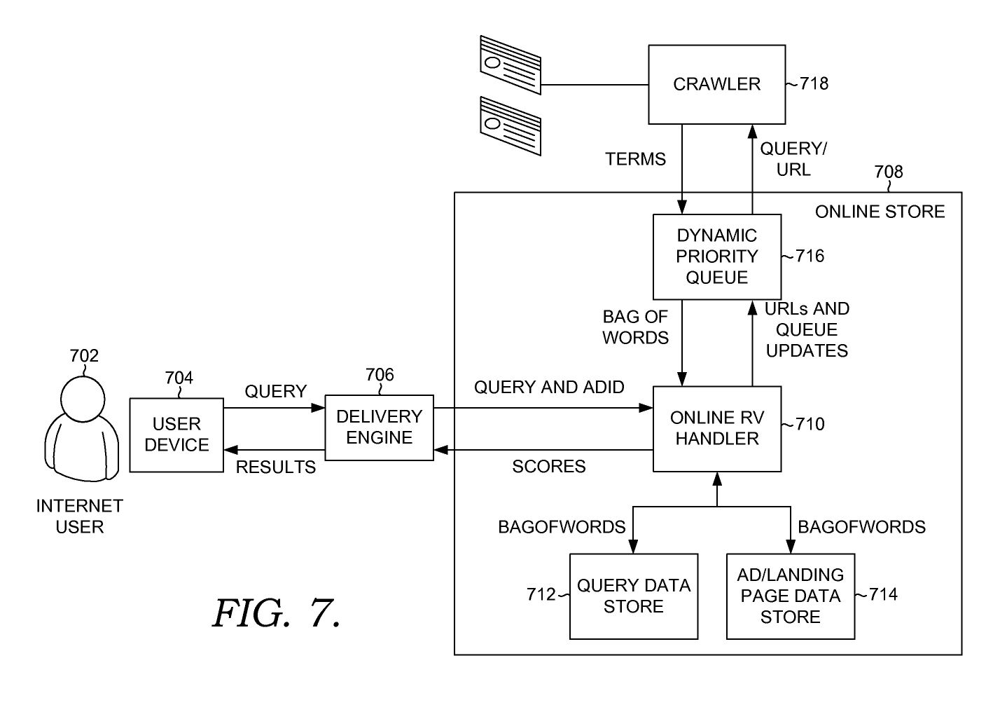

Having described the overall process of selecting relevant advertisements for search queries, a specific system architecture 700 and process for implementing one embodiment of the invention will now be described with reference to FIG. 7. The system provides relevant advertisements in response to search queries. In particular, an internet user 702 may employ a user device 704 to enter a search query. The search query is received at a delivery engine 706. Based on the received search query, a number of candidate advertisements are identified based on monetization factors, such as CPC bid and CTRs, for instance by performing an auction. Traditionally, these advertisements would be provided in response to the search query. In embodiments of the present invention, the relevance of the advertisements however is factored in determining what advertisements are ultimately returned to the user device 704.

The search query and advertisements determined based on monetization are provided to an online store 708, which facilitates online relevance verification for the advertisements. Typically, an identifier for each advertisement may be provided. In some cases, because the advertisements are associated with a landing page, an identifier for a landing page (e.g., a URL) may be provided instead of or in addition to its corresponding advertisement. Also, in some embodiments, only the top N (e.g., top 100) advertisements are passed to the online store.

As shown in FIG. 7, an online relevance handler 710 receives the search query and advertisement (and/or landing page) identifiers. Based on this input, the online relevance handler 710 queries a query data store 712 and advertisement/landing page data store 714 to access data for determining relevance scores. The query data store 710 includes information associated with a number of search queries. For each stored search query, the query data store 710 includes a collection of words and corresponding word scores. The collection of words are collected from search results for the given search query. In some embodiments, the words may be collected by crawling documents associated with the search results, while in other embodiments, the words may be collected from search result snippets. In some cases, the query data store includes the top N (e.g., top 100) words for a given search query which have been designated as dominants words for the search query.

The online relevance handler 710 queries the query data store 712 to determine if it contains the current search query. If the current search query is not stored in the query data store, the online relevance handler 710 returns default relevance scores to the delivery engine 706. Alternatively, if the current search query is stored in the query data store 712, the online relevance handler receives a word-bag comprising the collection of words and their corresponding word scores for the current search query.

Similar to the query data store 712, the advertisement/landing page data store 712 includes information associated with a number of advertisements and/or landing pages. For each stored advertisement/landing page, the advertisement/landing page data store 712 includes a collection of words and corresponding word scores. The collection of words are collected from the content of the landing page. In some cases, the advertisement/landing page data store includes the top N (e.g., top 100) words for a given advertisement/landing page which have been designated as dominants words for the advertisement/landing page.

The online relevance handler 710 queries the advertisement/landing page data store for each of the advertisements/landing pages identified by the delivery engine 706. Some advertisements/landing pages may not be stored in the advertisement/landing page data score 714. For such advertisements/landing pages, a default relevance score may be assigned and returned to the delivery engine. For each advertisement/landing page stored in the advertisement/landing page data store 714, a word-bag having a collection of words and their corresponding word scores is retrieved.

After retrieving information from the query data store 712 and the advertisement/landing page data store 714, the online relevance handler 710 calculates a relevance score for each of the advertisements/landing pages for which a word-bag was available from the advertisement/landing page data store 714. The relevance scores may be determined based on a matching algorithm, for instance, such as that described with reference to FIG. 6.

The relevance scores for the identified advertisements/landing pages are returned from the online relevance handler 710 to the delivery engine 706. The relevance scores may include both calculated relevance scores for those advertisements/landing pages for which data was available and default relevance scores for those advertisements/landing pages for which data was unavailable. The delivery engine 706 then selects and orders advertisements for return to the user device 704. As described previously, in some embodiments, irrelevant advertisements are filtered (e.g., based on a relevance threshold and the advertisements' relevance scores) and an auction is conducted using the relevant advertisements. In some cases, an auction does not need to be performed as the results of the auction previously performed by the delivery engine 706 are merely filtered based on the relevance scores. In other embodiments, the relevance scores may be used in conjunction with monetization factors to rank the advertisements without first filtering irrelevant advertisements. In further embodiments, relevance scores may be used to both filter advertisements and calculate ranking in conjunction with monetization factors. Any and all such variations are contemplated to be within the scope of embodiments of the present invention.

As indicated previously, in some cases, the query data store 712 may not contain a given search query or the advertisement/landing page data store 714 may not contain a given advertisement/landing page. In such cases, a message is sent to a dynamic priority queue 716 for the missing query or advertisement/landing page. The dynamic priority queue 716 is responsible for managing the priority of landing pages and search queries that need to be crawled using a crawler 718. Generally, the dynamic priority queue 716 will manage a list of landing pages and search queries that are sorted by number of hits (i.e., the number of times the dynamic priority queue has been requested to crawl a landing page or search query). When a query or advertisement/landing page are not currently stored, a message is sent to the dynamic priority queue 716. If the query or advertisement/landing page is not currently in the queue, the query or advertisement/landing page is added to the queue. Alternatively if the query or advertisement/landing page is currently in the queue, its priority may be adjusted by the request (i.e., the number of hits is incremented based on the request).

The dynamic priority queue 716 sends the top record to be crawled when the crawler 718 becomes available. Results for a given search query or advertisement/landing page will include a collection of words for which a word score is calculated for each word. The information is then stored in the appropriate location (i.e., query data store 712 or the advertisement/landing page data store). Accordingly, the information is available for subsequent search queries for use in determining relevance scores.

As can be understood, embodiments of the present invention provide relevant advertisements in response to a search query. Advertisement relevance is determined by comparing content from a landing page associated with a given advertisement against search results for a given search query. Relevance is used before, during, and/or after an auction to filter and/or rank advertisements to return for a search query.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A computerized method for providing advertisements in response to a search query, the method comprising:
receiving the search query;
determining a relevance score for an advertisement and the search query by comparing content of a landing page associated with the advertisement against search results for the search query;
selecting one or more advertisements based at least in part on the relevance score and at least one monetization factor; and
communicating the one or more advertisements for presentation.

2. The method of claim 1, wherein determining the relevance score for the search query and advertisement pair comprises:
accessing a first collection of words associated with the landing page;
determining word scores for the first collection of words;
accessing a second collection of words associated with search results for the search query;
determining word scores for the second collection of words; and
calculating the relevance score based on the word scores for the first collection of words and the word scores for the second collection of words.

3. The method of claim 2, wherein the word score for a given word is calculated based on the following formula: WordScore=(TF*log(N/DF))^{k}, wherein WordScore represents the word score, TF represents a frequency at which the given word appears in a document; N is the number of documents in a document corpus; DF is the number of documents in the document corpus that contain the given word; and k is a coefficient for enhancing result quality.

4. The method of claim 2, wherein calculating a relevance score based on the word scores for the first collection of words and the word scores for the second collection of words comprises:
calculating a cosine similarity based on the word scores for the first collection of words and the word scores for the second collection of words; and
calculating the relevance score based on the cosine similarity.

5. The method of claim 4, wherein the relevance score is calculated based on the following equation:
$$R = \frac{( N - {N}^{( 2 {cos}^{- 1} ( Cos Sim ) / π )} )}{( N - 1 )} ,$$
wherein R represents the relevance score, N is a system value, and CosSim represents the cosine similarity.

6. The method of claim 1, wherein selecting the one or more advertisements comprises:
comparing the relevance score against a relevance threshold;
if the relevance score meets the relevance threshold, including the advertisement in an auction process for selecting the one or more advertisements based at least in part on the at least one monetization factor; and
if the relevance score does not meet the relevance threshold, excluding the advertisement from the auction process.

7. The method of claim 1, wherein selecting the one or more advertisements comprises ranking the advertisement based at least in part on the relevance score and the at least one monetization factor.

8. The method of claim 1, wherein the at least one monetization factor comprises at least one of a cost-per-click bid and a click through rate.

9. One or more computer-readable media embodying computer-useable instructions for performing a method of providing a set of advertisements for a given search query, the method comprising:
accessing information regarding a set of search results for the given search query;
accessing information regarding content of a landing page associated with an advertisement;
calculating a relevance score indicative of the relevance of the advertisement for the given search query by comparing the information regarding the set of search results against the information regarding the content of the landing page;
in response to receiving a search request from a user including the given search query or an equivalent thereof, selecting a set of advertisements based at least in part on the relevance score for the advertisement and at least one monetization factor; and
communicating the set of advertisements for presentation.

10. The computer-readable media of claim 9, wherein the information regarding the set of search results for the given search query comprises a collection of dominant words for the set of search results and corresponding word scores, and wherein the information regarding content for the landing page comprises a collection of dominant words for the landing page and corresponding words scores.

11. The computer-readable media of claim 10, wherein the word score for a given word is calculated based on the following formula: WordScore=(TF*log(N/DF))^{k}, wherein WordScore represents the word score, TF represents a frequency at which the given word appears in a document; N is the number of documents in a document corpus; DF is the number of documents in the document corpus that contain the given word; and k is a coefficient for enhancing result quality.

12. The computer-readable media of claim 10, wherein calculating the relevance score comprises:
calculating a cosine similarity based on the word scores for the dominant words for the search query and the landing page; and
calculating the relevance score based on the cosine similarity.

13. The computer-readable media of claim 9, wherein selecting the set of advertisements comprises:
comparing the relevance score against a relevance threshold;
if the relevance score meets the relevance threshold, including the advertisement in an auction process for selecting the set of advertisements based at least in part on the at least one monetization factor; and
if the relevance score does not meet the relevance threshold, excluding the advertisement from the auction process.

14. The computer-readable media of claim 9, wherein selecting the set of advertisements comprises performing an auction process using the relevance score, wherein the auction process comprises:
calculating rankings for a plurality of advertisements based at least in part on a relevance score associated with each advertisement and at least one monetization factor associated with each advertisement;
selecting and ordering advertisements for the set of advertisements based on the rankings.

15. The one or more computer-readable media of claim 14, wherein the relevance score for at least one of the plurality of advertisements is a default relevance score.

16. One or more computer-readable media embodying computer-useable instructions for performing a method of providing a set of advertisements for a search query, the method comprising:
receiving the search query;
performing an auction based on at least one monetization factor to identify a set of candidate advertisements for the search query;
determining a relevance score for at least one candidate advertisement by comparing content from a landing page associated with the at least candidate advertisement against search results for the search query;
selecting a set of advertisements by removing one or more of the candidate advertisements from the set of candidate advertisements based on a relevance score; and
communicating at least a portion of the set of advertisements for presentation.

17. The one or more computer-readable media of claim 16, wherein the at least one monetization factor comprises at least one of a cost-per-click bid and a click through rate.

18. The one or more-computer-readable media of claim 16, wherein selecting a set of advertisements comprises comparing a relevance score against a relevance threshold.

19. The one or more computer-readable media of claim 16, wherein the method further comprises setting a default relevance score for at least one second candidate advertisement.

20. The one or more computer-readable media of claim 16, wherein determining the relevance score for at least one candidate advertisement comprises accessing a first word bag comprising a collection of words and corresponding word scores for the search query and a second word bag comprising a collection of words and corresponding word scores for the at least one candidate advertisement.
